(19) United States
(12) Patent Application Publication
(10) Pub. No.: US 2013/0183027 A1
(43) Pub. Date: Jul. 18, 2013

(54) BOTH SIDES EXPOSURE SYSTEM

(71) Applicant: SAMSUNG ELECTRO-MECHANICS CO., LTD., Suwon (KR)

(72) Inventors: Young Woo Lee, Suwon (KR); Sang Su Hong, Suwon (KR); Jung Ryoul Yim, Suwon (KR); Chung Mo Yang, Suwon (KR); Jae Hun Kim, Suwon (KR); Woo Jin Lee, Suwon (KR)

(73) Assignee: SAMSUNG ELECTRO-MECHANICS CO., LTD., Suwon (KR)

(21) Appl. No.: 13/743,638

(22) Filed: Jan. 17, 2013

(30) Foreign Application Priority Data
Jan. 18, 2012 (KR) 10-2012-0005814

(51) Int. Cl. G03B 1/00

(52) U.S. Cl. CPC G03B 1/00
USPC 396/335

(57) ABSTRACT

Disclosed herein is a both sides exposure system including: a first exposure part exposing one side of a film transferred by a transfer unit; an inversion part inverting one side and the other side of the film passing through the first exposure part; and a second exposure part exposing the other side of the inverted film inverted while passing through the inversion part.

### CROSS REFERENCE TO RELATED APPLICATION

This application claims the benefit of Korean Patent Application No. 10-2012-0005814, filed on Jan. 18, 2012, entitled “Both Sides Exposure System”, which is hereby incorporated by reference in its entirety into this application.

### BACKGROUND OF THE INVENTION

1. Technical Field

The present invention relates to a both sides exposure system.

2. Description of the Related Art

An exposure system has been used to form an electrode on a flexible substrate such as a flexible printed circuit board, a film having an electrode pattern for TSP sensor, and the like.

An exposure system according to a prior art has performed a both sides exposure such that an upper portion and a lower portion of a copper foil film releasing from a feed roll and then passing through the exposure system are exposed at the same position in order to improve exposure efficiency.

A substrate has been manufactured by allowing exposure light irradiated from a light source to pass through a mask and then be projected on a copper foil film to print patterns of the mask positioned on upper and lower portions of an exposure system on an upper and lower surfaces of the copper foil film during a period in which the copper foil film passes through the exposure system in the state in which upper and lower portions of the exposure system are provided with the light source and the mask.

However, in the case in which the substrate is manufactured by the method as described above, since the upper and lower portion of the copper foil film passing through the exposure system needs to be simultaneously exposed, a exposure light source having a separate configuration, the mask and an additional component need to be provided.

In particular, a high pressure mercury lamp is generally used as the light source generating the exposure light, wherein the high pressure mercury lamp is divided into an upper high pressure mercury lamp which is used for exposing the upper surface of the copper foil film and a lower high pressure mercury lamp which is used for exposing the lower surface of the copper foil film, but they have different shapes to each other, causing a problem that they are not compatible with each other.

Therefore, there is inconvenience to separately prepare the upper and lower high pressure mercury lamps in order to operate a both sides exposure system and there is also a problem that the efficiency of operating the exposure system is reduced. Since the high pressure mercury lamp which needs to be exchanged after operating for predetermined time as expandable part is separately prepared as the upper high pressure mercury lamp and the lower high pressure mercury lamp, respectively, the number of the high pressure mercury lamps which need to be secured to operate the both sides exposure system have increased. Therefore, in the case in which stocks of any one of the upper high pressure mercury lamp or the lower high pressure mercury lamp are totally consumed, there was a problem that an operation of the entire exposure system is interrupted.

In addition, worker needs to monitor an exposure working state of the copper foil film to reduce a defect, but it was difficult to monitor the working state at the time of exposing the lower surface of the copper foil film. Since a process of exposing the lower surface is not visible from the outside, it was inconvenient for the worker to monitor the lower surface of the copper foil film.

In addition, since the upper surface and the lower surface of the copper foil film are simultaneously exposed, the working condition of the upper surface and the working condition of the lower surface need to simultaneously set to perform the working. However, the working condition is not satisfied often, leading to occurrence of defects in the substrate to be produced.

### SUMMARY OF THE INVENTION

The present invention has been made in an effort to provide a both sides exposure system capable of exposing both sides of a film.

The present invention has been made an effort to provide a both sides exposure system capable of accurately exposing both sides of a film.

According to a preferred embodiment of the present invention, there is provided a both sides exposure system including: a first exposure part exposing one side of a film transferred by a transfer unit; an inversion part inverting one side and the other side of the film passing through the first exposure part; and a second exposure part exposing the other side of the inverted film inverted while passing through the inversion part.

The both sides exposure system may further include a hole formation part forming a position determination hole on the film before exposure is performed in the first exposure part.

The hole formation part may form the position determination hole along edges of the both sides of the film at a predetermined interval.

The both sides exposure system may further include a position recognition part recognizing a position of the position determination hole of the film.

The both sides exposure system may further include a case accommodating the hole formation part therein, wherein one side of the case is provided with a filter.

The inversion part may include a first roller laterally inverting the film with respect to a transfer central axis in which the film is transferred to the second exposure part; a second roller inverting again the film passing through the first roller to a direction of the transfer central axis; and a third roller inverting the film passing through the second roller to a transfer direction of the film.

The both sides exposure system may further include a foreign substance removal part removing foreign substances attached to the film after the film passes through the hole formation part.

The foreign substance removal part may be configured of adhesion rollers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a concept view of a both sides exposure system according to a preferred embodiment of the present invention;

FIG. 2 is a perspective view of an inversion part in the both sides exposure system according to the preferred embodiment of the present invention;

FIG. 3 is a concept view showing that a film is inverted and moved through a first roller and a second roller of the inversion part in the both sides exposure system according to the preferred embodiment of the present invention;

FIG. 4 is a perspective view showing the second roller of the inversion part in the both sides exposure system according to the preferred embodiment of the present invention; and

FIG. 5 is a perspective view of a film on which a position determination hole is formed in the both sides exposure system according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

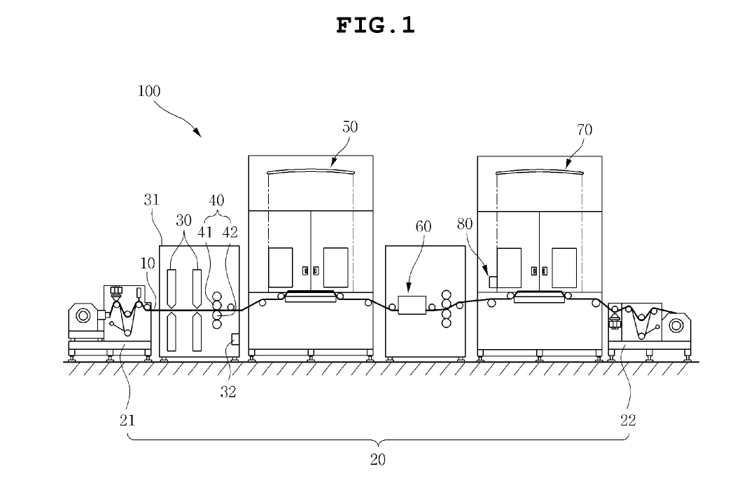

FIG. 1 is a concept view of a both sides exposure system according to a preferred embodiment of the present invention.

Referring to FIG. 1, a both sides exposure system 100 according to a preferred embodiment of the present invention includes a first exposure part 50 exposing one side of a film 10, an inversion part 60 inverting the film 10, and a second exposure part 70 exposing the other side of the film 10, thereby exposing both sides of the film 10.

In addition, the both sides exposure system 100 according to the preferred embodiment further includes a hole formation part 30 forming a position determination hole 11 on the film 10 and a position sensing part sensing the position determination hole 11, thereby sensing the position of the film 10.

Referring to FIG. 1, the first exposure part 50 exposes one side of the film 10 which is moved by a transfer unit 20.

In this case, the film 10 may be made of any one of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC), polyvinyl alcohol (PVA), polyimide (PI), polystyrene (PS), or biaxially oriented PS (BOPS; containing K resin). However, the film 10 of the both sides exposure system 100 according to the preferred embodiment of the present invention is not limited thereto.

In addition, the transfer unit 20 transfers the film 10 to the first exposure part 50 and the second exposure part 70. In this case, the transfer unit 20 may include a feed roller (not shown) and a plurality of transfer rollers (not shown).

In addition, the transfer unit 20 may include a feeding part 21 and a transfer part 22. In this case, the feeding part 21 has a winding roller around which the film 10 is wound at one side thereof and includes the feeding roller feeding the film 10 wound around the winding roller to the first exposure part 50 and the second exposure part 70.

In addition, the first exposure part 50 irradiates ultraviolet rays to downwardly expose one side of the film 10. In this case, the ultraviolet rays are selectively irradiated on one side of the film 10 to selectively cure one side of the film 10, thereby forming a pattern. As a result, the cured portion or uncured portion among one side of the film 10 may be selectively removed to form an electrode pattern on one side of the film 10.

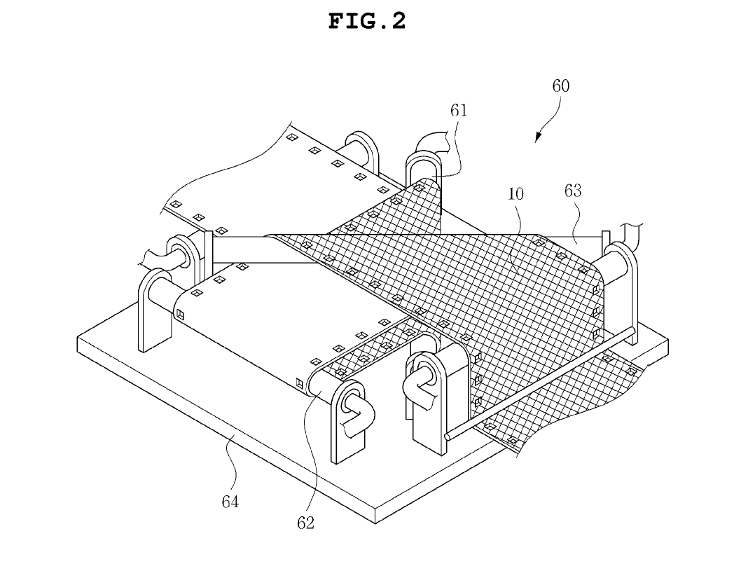

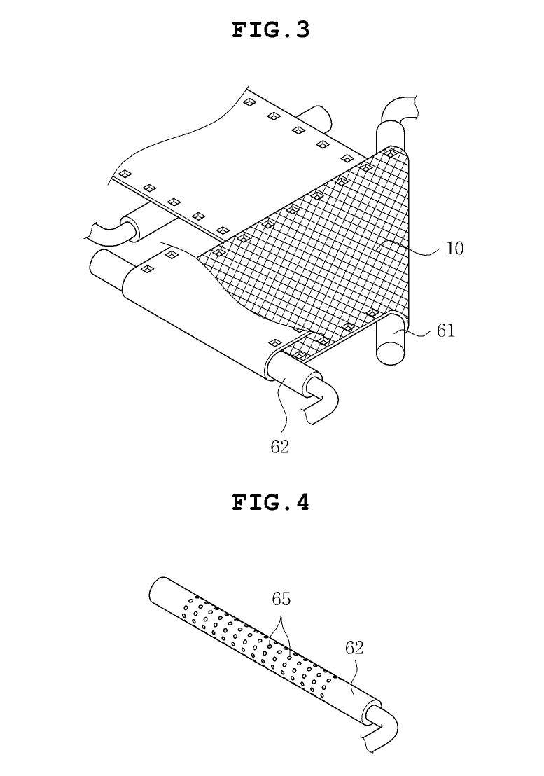

FIG. 2 is a perspective view of an inversion part in the both sides exposure system according to the preferred embodiment of the present invention, FIG. 3 is a concept view showing that a film is inverted and moved through a first roller and a second roller of the inversion part in the both sides exposure system according to the preferred embodiment of the present invention, and FIG. 4 is a perspective view showing the second roller of the inversion part in the both sides exposure system according to the preferred embodiment of the present invention.

Referring to FIGS. 1 and 2, the inversion part 60 mutually inverts one side and the other side of the film 10 passing through the first exposure part 50. As a result, one side of the film 10 exposed in the first exposure part 50 is downwardly positioned before moving to the second exposure part 70 and the other side of the film 10 unexposed in the first exposure part 50 is upwardly positioned before moving to the second exposure part 70.

In addition, referring to FIGS. 2 and 3, the inversion part 60 includes a first roller 61, a second roller 62, and a third roller 63. Furthermore, the inversion part 60 may further include a support frame 64 on which the first roller 61, the second roller 62, and the third roller 63 are mounted.

Herein, the first roller 61 laterally inverts the film 10 with respect to a transfer central axis in which the film 10 is transferred from the first exposure part 50 to the second exposure part 70. Herein, one side and the other side of the film 10 are inverted by the first roller 61 so that the other side of the film 10 is upwardly positioned. In this case, the film 10 is transferred, while being laterally inverted by 90° in a direction to be transferred to the second exposure part 70.

In addition, the second roller 62 inverts again the film 10 which is inverted through the first roller 61. Herein, one side and the other side of the film 10 are inverted by the first roller 61 so that one side of the film 10 is upwardly positioned. In this case, the film 10 is transferred toward the transfer central axis of the direction to be transferred to the second exposure part 70.

In addition, the third roller 63 inverts again the film 10 which is back-inverted through the first roller 62. Herein, the film 10 is inverted by the third roller 63 so that the other side thereof upwardly positioned. In this case, the film 10 is transferred to the direction to be transferred to the second exposure part 70.

Meanwhile, referring to FIG. 4, the first roller 61, the second roller 62 or the third roller 63 is provided with air holes 65 penetrating through an inner side and an outer side thereof, and when the air is injected into the inner side through an air injection unit such as an air compressor, the air is discharged through the air hole 65. In this configuration, as the air is discharged through the air holes 65, the film 10 positioned on the first roller 61, the second roller 62 or the third roller 63 may be transferred, while being spaced apart from an outer peripheral surface of the first roller 61, the second roller 62 or the third roller 63 at a predetermined interval.

Referring to FIG. 1, the second exposure part 70 exposes the other side of the inverted film 10 inverted while passing through the inversion part 60.

In this case, the other side of the film 10 is upwardly positioned, while passing through the inversion part 60, to be introduced into the second exposure part 70, and ultraviolet ray is selectively irradiated on the other side of the film 10 to selectively cure one side of the film 10 at the upper side of the second exposure part 70, thereby forming a pattern. As a result, the cured portion or uncured portion of one side of the film 10 may be selectively removed, whereby an electrode pattern may be formed on one side of the film 10.

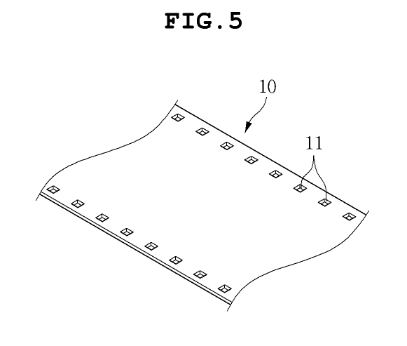

FIG. 5 is a perspective view of a film on which a position determination hole is formed in the both sides exposure system according to the preferred embodiment of the present invention.

Referring to FIGS. 1 and 5, the hole formation part 30 forms the position determination hole 11 on the film 10 before the exposure is performed in the first exposure part 50.

Herein, the hole formation part 30 is positioned between the feeding part 21 of the transfer unit 20 and the first exposure part 50, thereby forming the position determination hole 11 by punching the film 10 introduced into the first exposure part 50.

In addition, referring to FIG. 3, the position determination hole 11 is formed along edges of the both sides of the film at a predetermined interval. In this case, the position determination hole 11 may have a circular shape or a quadrangle shape by way of example, but the shape of the position determination hole 11 according to the preferred embodiment of the present invention is not necessarily limited thereto.

Meanwhile, the both sides exposure system 100 according to the preferred embodiment of the present invention further includes a case 31 and a filter 32. In this configuration, the hole formation part 30 is accommodated within the case 31 and the filter 32 is provided at one side of the case 31, thereby preventing foreign substances occurring at the time of forming the position determination hole 11 of the film 10 in the hole formation part 30 from being discharged to the outside.

Meanwhile, the both sides exposure system 100 according to the preferred embodiment of the present invention further includes a foreign substance removal part 40 removing foreign substances attached to the film 10 after the film 10 passes through the hole formation part 30.

Herein, the foreign substance removal part 40 may be configured of a plurality of adhesion rollers 41 and 42 to thereby remove the foreign substances attached to the both sides of the film 10. In this case, the transferred film 10 is positioned between the plurality of adhesion rollers 41 and 42, and the plurality of adhesion rollers 41 and 42 each contact both sides of the film 10, thereby making it possible to remove the foreign substances attached to the film 10.

Referring to FIG. 1, a position recognition part 80 is positioned on one side of the second exposure part 70 to sense the position determination hole 11 of the film 10, thereby recognizing the position of the film 10. In this configuration, the position recognition part 80 includes a position sensing sensor (not shown) provided at an inner upper side of the second exposure part 70 which senses the position determination hole 11 of the film 10.

According to the preferred embodiment of the present invention, both sides of the film may be exposed, thereby making it possible to form the electrode pattern on both sides of the film.

In addition, according to the preferred embodiment of the present invention, both sides of the film may be accurately exposed, thereby making it possible to accurately form the electrode pattern on both sides.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A both sides exposure system comprising:
a first exposure part exposing one side of a film transferred by a transfer unit;
an inversion part inverting one side and the other side of the film passing through the first exposure part; and
a second exposure part exposing the other side of the inverted film inverted while passing through the inversion part.

2. The both sides exposure system as set forth in claim 1, further comprising:
a hole formation part forming a position determination hole on the film before exposure is performed in the first exposure part.

3. The both sides exposure system as set forth in claim 2, wherein the hole formation part forms the position determination hole along edges of the both sides of the film at a predetermined interval.

4. The both sides exposure system as set forth in claim 2, further comprising:
a position recognition part recognizing a position of the position determination hole of the film.

5. The both sides exposure system as set forth in claim 2, further comprising:
a case accommodating the hole formation part therein,
wherein one side of the case is provided with a filter.

6. The both sides exposure system as set forth in claim 1, wherein the inversion part includes:
a first roller laterally inverting the film with respect to a transfer central axis in which the film is transferred to the second exposure part;
a second roller inverting again the film passing through the first roller to a direction of the transfer central axis; and
a third roller inverting the film passing through the second roller to a transfer direction of the film.

7. The both sides exposure system as set forth in claim 2, further comprising a foreign substance removal part removing foreign substances attached to the film after the film passes through the hole formation part.

8. The both sides exposure system as set forth in claim 7, wherein the foreign substance removal part is configured of adhesion rollers.
